(19) United States
(12) Patent Application Publication
(10) Pub. No.: US 2004/0262018 A1
(43) Pub. Date: Dec. 30, 2004

(54) Fire extinguishing cover

(76) Inventor: Richard Roussin, Gatineau (CA)

Correspondence Address: JACK PAAVILA, BOX 1151, ALEXANDRIA, KOC IA0, CA

(21) Appl. No.: 10/862,366

(22) Filed: Jun. 8, 2004

(30) Foreign Application Priority Data
Jun. 16, 2003 (CA) 2,432,480

(51) Int. Cl. A62C 35/02

(52) U.S. Cl. 169/50; 169/49

(57) ABSTRACT

A flexible, fire extinguishing cover made from known fire proof material. The cover is sized to cover an object when the object is burning to starve it of air. The cover has at least one small opening therein to introduce a fire extinguishing gas into the space enclosed by the cover.

A fire extinguishing kit having a fire extinguishing cover, a fire extinguisher, and a small bag. The fire extinguishing cover is sized to cover an object when the object is burning to starve it of air. The cover has at least one small opening therein to introduce a fire extinguishing gas, supplied by the fire extinguisher, into the space enclosed by the cover. The small bag is sized to compactly store both the cover and the fire extinguisher together.

A method of extinguishing a fire on an object comprising the steps of covering the object with a flexible cover made of fire proof material, the cover having at least one closed opening therein; opening the closed opening; and injecting a fire extinguishing gas through the opening into the space enclosed by the cover.

### BACKGROUND OF THE INVENTION

1. Field of the Invention

This invention is directed toward a fire extinguishing cover and a method of using the cover. The invention is particularly directed toward a fire extinguishing cover sized to cover a vehicle such as an automobile or truck, to extinguish a fire in the vehicle. The invention is also directed toward a fire extinguishing kit employing the cover.

2. Description of the Related Art

A fire extinguishing cover in the form of a large, flexible, panel is well known. The cover is normally made of fire proof material and is sized to cover objects that can burn. covering the burning object with the cover cuts off the oxygen from the fire causing the fire to go out. Examples of simple fire extinguishing covers are shown in U.S. Pat. Nos. 4,624,320 and 4,597,450. The covers can be provided with handles, to make handling of the cover to cover a fire easier, and with weights about their periphery to retain the cover over the fire, as shown in U.S. Pat. No. 5,083,617 by way of example. These known covers, while eventually smothering the fire may not act quickly enough to minimize damage from the fire. It is also known to provide a cover with holes therein to allow air to escape from under the cover when the cover is thrown over a fire so as to allow the cover to settle more closely onto the fire to more quickly smother it and put out the fire. See U.S. Pat. No. 2,720,269 for an example. The holes however allow air to the fire and may result in the fire continuing to burn. It is further known, as shown by U.S. Pat. No. 5,146,996, to provide a cover that can have fire extinguishing material pumped in under the cover. However it would appear that the material must be pumped in under the cover from the edge of the cover. Lifting the cover to introduce the material could allow the material to partially escape. Further, the material is not directly applied to the center of the fire. Both situations may result in delay in extinguishing the fire.

### SUMMARY OF THE INVENTION

It is the purpose of the present invention to provide a fire extinguishing cover that, when employed with fire extinguishing material, extinguishes fires more quickly than known covers. It is another purpose of the present invention to provide a fire extinguishing kit that employs both the fire extinguishing cover of this invention and a dispenser of fire extinguishing material. It is a further purpose of the present invention to provide a method of using the fire extinguishing kit.

In accordance with the present invention a fire extinguishing article in the form of a fire proof cover is provided with a plurality of small openings in the cover which openings are normally closed. The openings are each normally closed by suitable closure means such as a flap attached to the cover. An opening, when opened by moving the flap, allows a fire extinguishing material, such as carbon dioxide, to be sprayed or injected into the space enclosed by the cover during use of the cover. The carbon dioxide accelerates extinguishing of the fire covered by the cover. The cover is preferably provided with a plurality of openings spaced apart in the central portion of the cover. Each opening is relatively small, sized to just allow entry of a fire extinguisher material dispensing nozzle through the cover during its use, the fire extinguisher material dispenser of the type dispensing a fire extinguishing gas. When the cover is deployed and gas is inserted under the cover through one of the openings which is uncovered, the gas is retained in the immediate vicinity of the fire by the cover to help extinguish the fire.

The cover can also be provided with strap extensions which allow the cover to be more easily handled and positioned without getting too close to the fire. The straps and/or the periphery of the cover can also be provided with weights which hold the edge of the cover more closely to the ground allowing the cover to more easily close off the burning object to air and to retain the fire extinguishing gas within the cover.

In one embodiment of the invention, the cover can be combined with a small portable fire extinguisher to provide a fire extinguishing kit. The cover and fire extinguisher could be packaged together in a compact manner for storage with the package easily opened to provide access to both the cover and the extinguisher to combat a fire.

The cover is sized for the particular type of fire it is meant to extinguish. For example, there may be one size of cover for covering automobiles to put out automobile fires and another size of cover for covering a stove top, to put out a grease fire in a pan on the stove.

The invention is particularly directed toward a flexible fire extinguishing cover made from known fire proof material, the cover sized to enclose at least part of an object when the object is burning to starve the fire of air. The cover has at least one small, closeable, opening generally in its center, the opening used to introduce a fire extinguishing gas into the space enclosed by the cover.

The invention is also particularly directed toward a fire extinguishing kit having a flexible fire extinguishing cover made from known fire proof material, the cover sized to enclose at least part of an object when the object is burning to starve the fire of air. The cover has a plurality of spaced-apart, small, closeable, openings generally in the central region of the cover, any one of the openings used to introduce a fire extinguishing gas into the space enclosed by the cover. The kit includes a fire extinguisher supplying a fire extinguishing gas when operated and a small bag sized to compactly store both the cover and the fire extinguisher together.

The invention is further particularly directed toward a method of extinguishing a fire on an object comprising the steps of covering the object with a flexible cover made of fire proof material, the cover having a plurality of closed openings therein; opening one of the closed openings; and injecting a fire extinguishing gas through the opening into the space enclosed by the cover.

### BRIEF DESCRIPTION OF THE FIGURES IN THE DRAWINGS

FIG. 1 shows a cover opened up with the openings therein closed,

FIG. 2 shows a detail of an open opening in the cover;

FIG. 3 shows another embodiment of a fastener for an opening;

FIG. 4 shows another embodiment of an opening for the cover; and

FIG. 5 shows a kit, employing the cover, in disassembled form.

### DESCRIPTION OF THE PREFERRED EMBODIMENTS

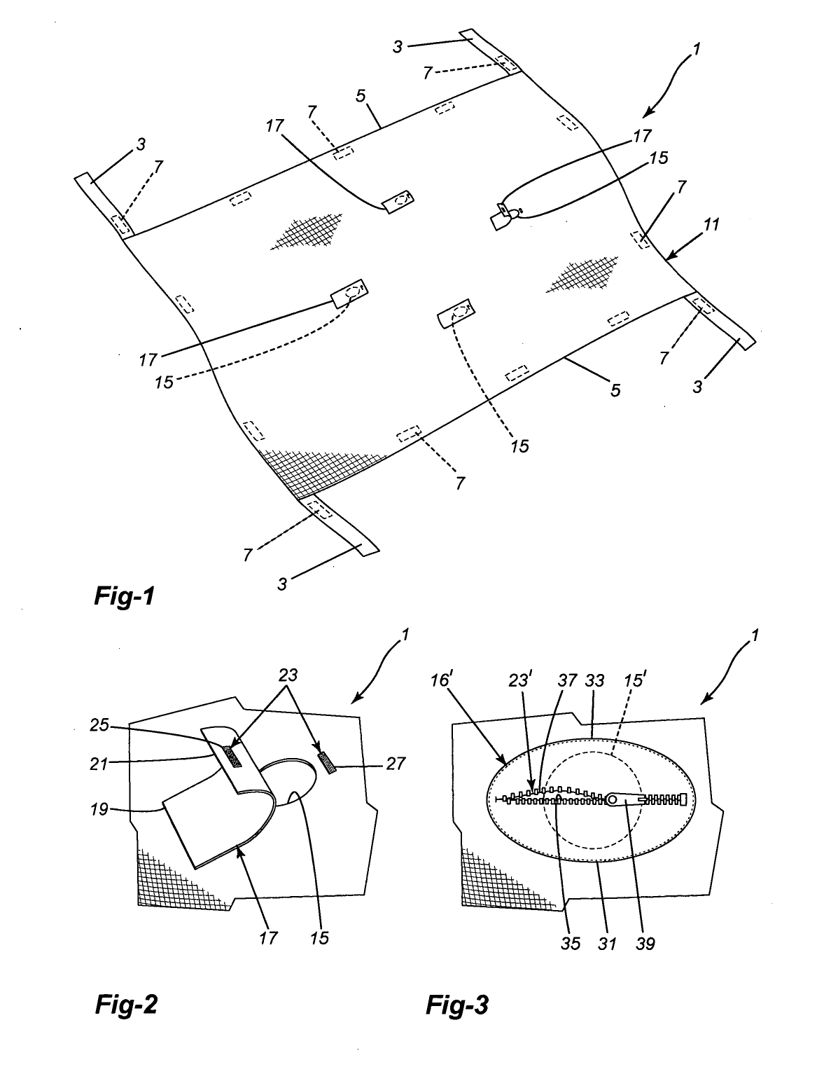

The flexible cover 1 is made from suitable, known, fireproof material. Some examples of suitable fireproof material are: woven cotton or linen material treated with known fire retardant chemicals to make burning of the material difficult; woven glass fibers; or aramid fabric such as Kevlar®. The cover has a shape and size to easily cover the particular object it is meant to extinguish fires on or in. The cover usually has a quadratic shape as shown in FIG. 1, but it can have other shapes as well depending on the object it is designed to protect.

Straps 3 can extend from at least two opposed sides 5 of the cover 1 to provide means for handling the cover to place it in operative position over a burning object. The straps 3 can be weighted with lead weights 7, as shown, to help to hold the cover in operative position covering the burning object. Alternatively, or in addition to the weighted straps, the peripheral edge 11 of the cover 1 can be weighted. Individual lead weights have been shown to provide the weighting. Other forms of weights can be used such as sand or lead shot confined in pockets formed in the straps and/or about the peripheral edge of the cover.

The cover 1 is provided with a number of small openings 15 therein, the openings spaced about the cover but more centrally located on the cover than peripherally. The openings 15 are in the form of small circular holes. Closure means 16 are provided for normally closing the openings 15. The closure means 16 for each opening can comprise a flexible flap 17 as shown in FIG. 2 with one side 19 of the flap 17 attached to the cover 1, the flap 17 extending over the opening 15 from its one side and attached at its other side 21 to the cover 1 with suitable fastening means 23. The fastening means 23 could comprise velcro® fastening elements with one fastening element 25 fixed to the flap 17 and a second complementary fastening element 27 fixed to the cover 1. Other types of fastening means 23 to close the flaps 17, such as zippers, buttons, snaps, or the like, could be used.

Any opening 15 can be easily uncovered by moving the flap 17 that normally closes it. The nozzle of a carbon dioxide fire extinguisher can be inserted into the open opening to spray carbon dioxide into the restricted space under the cover when it covers a burning object, so as to speed up extinguishing of the fire. The openings are sized to have the nozzle of the fire extinguisher just fit through the opening so that a minimum amount of air enters the fire area under the cover.

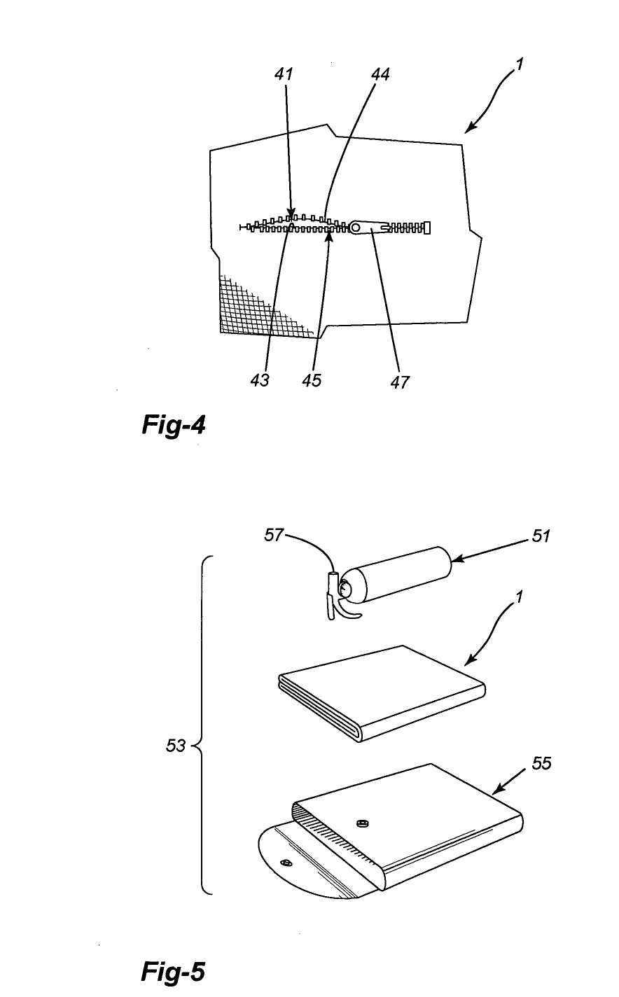

While the closure means 16 for the openings 15 have been described as flaps 17, they can also comprise other forms of closures. The closure means 16′ can, for example, comprise abutting panels 31, 33 fastened to the cover adjacent the opening 15′ and overlying the opening as shown in FIG. 3. The edges 35, 37 of the panels 31, 33 are closed by fastening means 23′ such as a zipper 39 or the like. In another embodiment, the closure means 16 could comprise a rupturable membrane (not shown) closing the opening. The membrane could be penetrated by pushing the nozzle against and through the membrane when the cover is being used. covers with such membranes could be single use covers.

The openings 15 have been shown as circular holes. They can have other shapes, or even other forms as well however. The openings could, for example, be formed by slits 41 in the cover, as shown in FIG. 4. The edges 43, 44 of each slit 41 are normally joined by connecting means 45 such as zippers 47, or interlocking rib and groove fasteners such as employed on plastic bags, to close the slits. The selected slit 41 can be opened when it is required to insert a gas dispensing nozzle through the cover.

The area of the cover adjacent the openings and/or the closure means closing them, can be distinguished by a colour different from the colour of the remainder of the cover so the openings can be easily and quickly found. other markings can be used to distinguish the openings. The center of the cover could be marked with a distinguishing mark such as an ‘X’ or a bullseye to assist the user in centering the cover over a fire.

In use, the cover 1 is packaged in a compact manner and located where it is handy in emergencies. For, example, the cover can be located with emergency vehicles such as a fire engine, a police car, or with an ambulance. If the emergency vehicle encounters a fire, the cover is retrieved, unfolded and placed over the object on fire. The cover is sized large enough to have its edges rest on the ground while covering the object so as to seal the space around the object and to starve the fire of air. The openings 15 on the cover 1 are closed at this time so that air cannot reach the fire through the openings. If a fire extinguisher is available, one of the openings 15 is opened and the nozzle of the fire extinguisher is inserted through the opening into the space enclosed by the cover. Operation of the extinguisher will fill the space enclosed by the cover with a non-flammable gas further starving the fire and putting it out more quickly.

In one embodiment of the invention, the cover 1 with the openings 15 therein can be combined with a small portable fire extinguisher 51 to provide a small compact fire extinguishing kit 53. The fire extinguisher 51 and the folded cover 1 are compactly stored in a flexible bag 55 or the like and removed from the bag for use when needed. The bag 55 retains the cover 1 and the fire extinguisher 51 in close proximity to each other till needed. the cover 1 will have the openings 15 therein sized to just receive the nozzle 57 of the fire extinguisher 51 associated with the cover in the kit 53 so as to minimize the entry of air through the opening to the fire.

The cover has been described as being used with carbon dioxide fire extinguishers. However fire extinguishers using other types of gases, such Halon 1301 which is non-toxic, can be used with the cover.

By way of example, a cover to be used to extinguish vehicle fires can be square in shape and about thirty six feet long along one side. Such a cover would be large enough to cover even large vehicles such as vans and SUV's. The straps employed to place the cover over the vehicle and tighten the cover about the vehicle can about six feet long. The openings would be in the central region of the cover, the openings nearest to the edge of the cover being about eight feet from the edge. Smaller covers could be employed for smaller vehicles. In all cases the cover is small enough to handled by one person.

The cover has been described as employing a plurality of openings. However, a small cover, such as used for stove fires, could be used with just one central opening.

I claim:

1. A flexible fire extinguishing cover made from known fire proof material, the cover sized to enclose an object when the object is burning to starve the fire of air, the cover having at least one small, closeable, opening generally in its center, the opening used to introduce a fire extinguishing gas into the space enclosed by the cover.

2. A cover as claimed in claim 1 wherein the opening is normally closed by removable closure means.

3. A cover as claimed in claim 2 including fastening means for maintaining the closure means in a closed position over the opening.

4. A cover as claimed in claim 1 wherein the opening in the cover is just large enough to pass the nozzle of a fire extinguisher.

5. A flexible fire extinguishing cover made from known fire proof material, the cover sized to enclose an object when the object is burning to starve the fire of air, the cover having a plurality of spaced-apart, small, closeable, openings generally in the central region of the cover, any one of the openings used to introduce a fire extinguishing gas into the space enclosed by the cover.

6. A cover as claimed in claim 5 wherein each opening is normally closed by removable closure means.

7. A cover as claimed in claim 6 including fastening means for maintaining the closure means in a closed position over the opening.

8. A cover as claimed in claim 5 wherein each opening in the cover is just large enough to pass the nozzle of a fire extinguisher.

9. A cover as claimed in claim 5 wherein the cover has straps extending from its peripheral edge.

10. A cover as claimed in claim 5 wherein the cover has weights adjacent its peripheral edge.

11. A fire extinguishing kit having:
a flexible fire extinguishing cover made from known fire proof material, the cover sized to enclose an object when the object is burning to starve the fire of air, the cover having a plurality of spaced-apart, small, closeable, openings generally in the central region of the cover, any one of the openings used to introduce a fire extinguishing gas into the space enclosed by the cover.
a fire extinguisher supplying a fire extinguishing gas when operated;
and a small bag sized to compactly store both the cover and the fire extinguisher together.

12. A fire extinguishing kit as claimed in claim 11 wherein the fire extinguisher has a nozzle and each opening in the cover is sized to just allow passage of the nozzle through the cover.

13. A method of extinguishing a fire on an object comprising: covering the object with a flexible cover made of fire proof material, the cover having a plurality of closed openings therein; opening one of the closed openings; and injecting a fire extinguishing gas through the opening into the space enclosed by the cover.
